(19) United States
(12) Patent Application Publication
(10) Pub. No.: US 2003/0176281 A1
(43) Pub. Date: Sep. 18, 2003

(54) Choice of chromophores in two color imaging systems

(76) Inventor: Bror O. Hultgren, Ipswich, MA (US)

Correspondence Address: POLAROID CORPORATION, PATENT DEPARTMENT, 1265 MAIN STREET, WALTHAM, MA, 02451, US

(21) Appl. No.: 10/350,856

(22) Filed: Jan. 23, 2003

Related U.S. Application Data
(60) Provisional application No. 60/364,180, filed on Mar. 13, 2002.

(51) Int. Cl. B41M 5/30

(52) U.S. Cl. 503/204

(57) ABSTRACT

A method for selecting two dye chromophores to render images is disclosed in which the second dye chromophore is selected to be the complement of the first dye chromophore and the first chromophore is selected to have a hue substantially equal to a fleshtone. In this manner the color of the visually most important elements of the scenes—flesh tones and neutrals—are accurately reproduced.

### REFERENCE TO RELATED APPLICATION

This application claims the benefit of prior copending provisional application serial no. 60/364,180, filed Mar. 13, 2002.

### FIELD OF THE INVENTION

The present invention relates to printing of color images utilizing a two color system, and, more specifically, to the printing of natural scenes by means of two colors, in such a manner that the most visually and aesthetically important portions of the images are rendered with the highest color fidelity.

### BACKGROUND DESCRIPTION

With the advent of personal computers and the availability of affordable color printers, the production of color images has greatly increased. Commercially available color printers utilize three or four color producing means such as different dyes or pigments (for example, cyan, magenta, yellow, and/or black) to render an image. (Herein after such color producing means will be referred to as dye chromophores.)

It is known in color science that any color can be represented by three numbers or three basic colors (see, for example W. F. Schreiber, Fundamentals of Electronic Imaging Systems, Second edition, Springer—Verlag, New York, N.Y., 1991,pp. 170-182 or G. Field, ‘Color and Its Reproduction’ Second Edition, GATF Press, Pittsburgh, Pa., 1999). Since any real color can be represented by three numbers, any real color can be represented as a point in a three dimensional space. In such a space, all points on a line through the origin have the same ratio of the three primary colors and differ only in brightness or “luminance”. It is then possible to define normalized color coordinates where the sum of such normalized coordinates is unity and, therefore, only two of the coordinates are independent. Thus, any real color can be represented in terms of two of such independent coordinates and a brightness or “luminance” coordinate. Several such color spaces have been proposed and used. Examples are the CJELuv color space, the Munsell color space utilizing brightness, hue, and chrominance as coordinates, and the CIELab color space. In the CIELab color space, a * and b * are the color coordinates and L * is the luminance coordinate. The CIE Lab color space can be related to the Munsell color space by defining a radial coordinate system where the chroma, C*, is the radius and defined by

(C*)²=(a *)²+(b *)²

H* corresponds to hue and is the azimuthal coordinate.

Some imaging systems have utilized less than three color producing means, for example those described in U.S. Pat. No. 3,895,173 and U.S. Pat. No. 4,627,641. These imaging systems have been tailored to specific applications where a full-color reproduction is not required. Duotone printing is well known in the graphic arts as a technique for enhancing a gray-scale image.

U.S. Pat. No. 5,982,924 discloses a method for rendering a full color image as a duotone by a choice of inks and mapping such that the color difference between the full color image and the duotone is minimized. In U.S. Pat. No. 5,982,924, the color difference is quantified as a mean square error of the pixelwise color errors in a visually uniform color space averaged over the total image. However, the penultimate paragraph of U.S. Pat. No. 5,982,924 asserts that “the present invention has no sense of what parts of images are semantically or aesthetically important.”

### SUMMARY

It is an object of this invention to enable the quality representation of natural scenes by means of two dye chromophores, in such a manner that the most visually and aesthetically important portions of the images are rendered with the highest color fidelity.

In an image forming system with two dye chromophores, the available color gamut is a two dimensional surface in color space. Since the color gamut of colors in a full color image describes a three-dimensional solid in the color space, the two-dye chromophore imaging system will of necessity only reproduce a subset of the colors in the source image. The object of this invention is to select two color forming elements, dye chromophores, D1 and D2, such that the color gamut defined by them contains or lies very close to the colors representing the visually most important elements of the scene; i.e., flesh tones and neutrals, and yet spans as much color space as possible.

To satisfy the object of this invention, a method for selecting two dye chromophores to render images is disclosed wherein the second dye chromophore is selected to be at least the approximate complement of the first dye chromophore, as will be described in detail hereinafter, and wherein the first chromophore is selected to have a hue substantially equal to a fleshtone. In this manner the color of the visually most important elements of the scenes, flesh tones and neutrals, are accurately reproduced.

To further satisfy the object of this invention, a method of rendering images by means of a printing system utilizing two dye chromophores is disclosed wherein a mapping of three-color image data in a uniform color space to the reduced color value space of the two dye chromophores is determined. In satisfying the object of this invention, that mapping is constructed by requiring that each input value in the image color space be mapped to the output value with the smallest metric distance from the input image color value. The metric distance being computed can be computed by weighting the three components of distance in the uniform color space to produce the most pleasing rendition. When the components of distance in the color space are denoted by Lightness, Chroma and Hue, the objects of this invention are realized by weighting the Lightness errors greater than Hue errors and weighting Hue errors greater than Chroma errors.

The methods for choosing the two dye chromophores do not depend on the specific technology of the imaging system. For example, the methods could be applied to thermal, ink jet, printing—e.g. offset printing, gravure printing etc.—or photographic imaging systems.

### DESCRIPTIONS OF THE DRAWINGS

The file of this patent contains at least one drawing executed in color. Copies of this patent with color drawing(s) will be provided by the Patent and Trademark Office upon request and payment of the necessary fee.

The novel features that are considered characteristics of the invention are set forth with particularity in the appended claims. The invention itself, however, both as to its organization and its method of operation, together with other objects and advantages thereof will be best understood from the following description of the illustrated embodiment when read in connection with the accompanying drawings wherein:

FIG. 1a depicts the color gamut for a 2-color printing system of this invention displayed as a projection onto the a*b* plane in visually uniform CIELAB space. The a*b* coordinates of a flesh tone and a neutral are also displayed;

FIG. 1b depicts the color gamut for a 2-color printing system of this invention displayed as a projection onto the L*C* plane in visually uniform CIELAB space;

FIG. 2a depicts the spectra of a Model Dye Chromophore and its complement according to this invention;

FIG. 2b depicts the color gamut for a Model Dye 2-color printing system of this invention displayed as a projection onto the a*b* plane in visually uniform CIELAB space;

FIG. 2c depicts the color gamut for a Model Dye 2-color printing system of this invention displayed as a projection onto the L*C* plane in visually uniform CIELAB space;

FIG. 3a depicts the spectra of a dye chromophore and its complement—the red dye described in U.S. Pat. No. 3,730,725 and Direct Green 75 Colour Index;

FIG. 3b depicts the color gamut for a 2-color printing system of this invention utilizing the red and green dyes of FIG. 3a displayed as a projection onto the a*b* plane in visually uniform CIELAB space;

FIG. 3c depicts the color gamut for a 2-color printing system of this invention utilizing the red and green dyes of FIG. 3a displayed as a projection onto the L*C* plane in visually uniform CIELAB space;

FIG. 4a depicts a color mapping applied to 2-color reproduction as obtained by an embodiment of this invention;

FIG. 4b depicts a full color reproduction (sRGB) of a MacBeth color target and a color proof of a simulation of a 2-color reproduction according to an embodiment of the invention;

FIG. 5 depicts three full color portraits (sRGB) and ‘color proofs’ of corresponding simulations of a 2-color reproduction according to an embodiment of this invention;

FIG. 6 depicts an ultrasound scan (sRGB) and a color proof of a simulation of a 2-color reproduction according to an embodiment of this invention;

FIG. 7 depicts an embodiment of a printing system of this invention; and

FIG. 8 depicts an embodiment of a printer of this invention.

### DETAILED DESCRIPTION

All color rendering methods introduce color errors. Hence the goal of any such color rendering method is to minimize the color reproduction errors in the elements of the full color image that the viewer judges most important. Visually uniform color spaces are constructed by the determination of just noticeable differences in the comparison of two color samples. In this spirit, the use of visually uniform color spaces to measure color error is appropriate only when the color errors approximate the limits of color differentiation. The process of rendering an image in a 2-color system obviously is characterized by very large color errors. It is important to identify the elements of the full color image that the viewer considers to be most important to render the image accurately.

Image science experience has shown that, the color reproduction criterion that is most highly correlated with image quality is the ability to reproduce neutrals and fleshtone colors. (see, for example, R. W. G. Hunt, The Reproduction of Colour, Fountain Press, Hertfordshire, England, 1975, pp.180-184 for a definition of fleshtones). Since the object of the invention is to render the visually most important elements of the full color image, it is of paramount importance that the color rendering method, and the determination of color errors be consistent with this knowledge. U.S. Pat. No. 5,982,924 makes no claim to reproduce the aesthetically important neutral gray and the invention described in U.S. Pat. No. 5,982,924 “has no sense of what parts of images are semantically or aesthetically important.”

Dye Chromophore Choice

Any two chromophores will determine a color gamut that defines a 2-dimensional surface in color space. The complement of a dye chromophore D1 is defined to be the chromophore that when combined with D1 in some proportion produces a color that is metameric (i.e. is indistinguishable from) to a neutral gray. In the case where the two complementary dye spectra, when combined, produce a flat spectral energy distribution, the two dyes describe an exact complementary pair. Where the resulting combined spectrum does not represent a uniformly flat spectral energy distribution, yet represents a color that is metameric to a neutral gray, the two dyes may be considered to be approximate complements. It should be noted that only in the case of exact complementary pairs of dyes can a neutral gray color be reproduced at all levels of lightness. In the case of approximate complementary chromophores the resulting metameric neutral may be sufficiently neutral to produce high quality textual and barcode reproductions. It should be understood that when reference is made herein to a dye and its complement, the term “complement” includes exact complements and approximate complements.

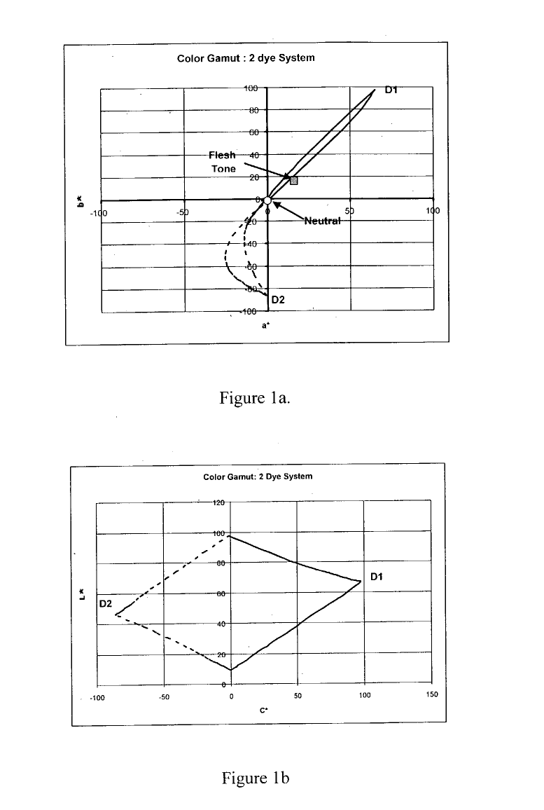

FIGS. 1a and 1b show the hue and chroma of colors produced by a complementary 2-dye system of this invention displayed both in an a*b* and an L*C* plot. In FIGS. 1a and 1b, the indicated lines represent the edges of a two-dimensional slice through the color space as viewed along the lightness axis in FIG. 1a, and perpendicular to the two-dimensional surface in FIG. 1b.

The two-dimensional color gamut produced by a dye and its complement will be a two dimensional surface passing through the neutral axis of a color space. Such dye pairs are useful because in addition to producing hues of the two spot colors, they will render text in a pleasing manner and barcode information compatible with UPC standards. An example of such a system application would be the use of a ‘blue-yellow’ dye pair to render thermal false color scales in medical imagery. Such a system can also render the underlying gray scale imagery as well as combining the gray scale image with the thermal false color scale overlay image.

For ‘real imagery’, two dye imaging systems will render a wide class of images in an acceptable manner since the chromophores can be chosen to correctly render skin tones (and neutral grays) which constitute the most important objects of known color in real images.

The method of this invention for choosing the two dye chromophores does not depend on the specific technology of the imaging system. For example, the method could be applied to thermal, ink jet, printing—e.g. offset printing, gravure printing etc.—or photographic imaging systems.

The following color reproduction criteria, according to this invention, provide a sufficient condition for the choice of the chromaticities of the two dye chromophores:

In order to reproduce the chromaticity of flesh the chromaticity of one dye chromophore will have the same hue as fleshtone.

In order to produce neutrals the second dye chromophore must be complementary to the first.

In order to reproduce as many distinct colors as possible, the chromophores preferably should be highly saturated.

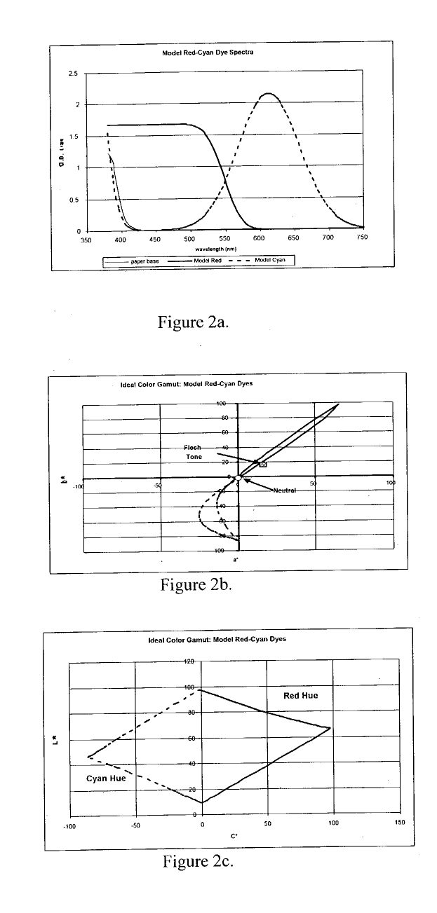

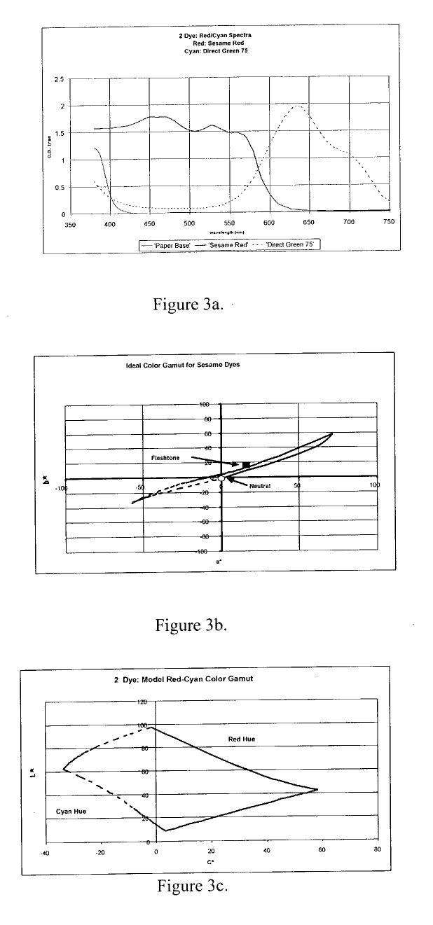

Lines of constant hue appearance do not transcribe straight lines in a uniform color space. Hence, the preferred method for determining the appropriate chromaticity to represent the fleshtone is to apply a model of the dye chromophore as transferred to the media substrate. The chromaticity of the pure dye is chosen such that when mixed with either the complementary chromophore or black (in varying strength) and the color of the underlying substrate the resulting spectral reflectance will produce the known hue of skin tone. In the embodiment where the first dye chromophore is mixed with black and the color of the underlying substrate to produce the known hue of skin tone, black is then, in effect, the second dye chromophore used. Note that the complementary pair of dyes reproduces neutral colors from black to white. See FIG. 2a for an example of a Red-Cyan complementary pair of model dyes. While the dye spectra shown in FIG. 2a represent ideal spectra, real dyes can be found that closely approximate these dyes. The choice of the red dye described in U.S. Pat No. 3,730,725 satisfies the hue requirement for flesh tone reproduction. Colour Index ‘Direct Green Dye 75’ functions as the complement to the above-mentioned red dye and the resulting color gamut can be shown to be nearly equivalent to the gamut shown in FIG. 2. The dye spectra associated with the complementary pair of red and green dyes are shown in FIG. 3a, with their associated color gamut. Both these dyes are water soluble dyes; as such they could be used as primary dyes for a two color implementation in ink jet printing, offset lithography or dye transfer printing. (It is recognized that the specific printing technology will impose additional constraints on the material requirements for their use as in a given application) These dye spectra are shown here to illustrate that known dyes can be shown to satisfy the conditions of the invention.

For systems used to reproduce a spot color rather than a flesh tone (e.g. for labeling) it is also advantageous to reproduce neutral. Thus the chromaticity of the spot color and the requirement to reproduce neutral (for example a black-subject to bar code scanning specification) is sufficient to choose the dye spectra.

Color Mapping for a two-dye chromophore System

Since most images and text are described as three color images—e.g. sRGB—all printers invoke techniques of color management to control the deposition of three or more dyes, such as Cyan, Magenta, Yellow and Black. Color Management specifies a method whereby every color in the full color image is rendered as a color capable of being printed by the printer. This process is called color mapping or color gamut tucking. As noted earlier, the mapping process is always is associated with errors in color reproduction. The distribution of color reproduction errors determines the quality of a color management system.

Typically the image data is coded in eight bits/channel where black is coded as value (0, 0, 0), white as (255, 255, 255), red as (255, 0, 0), cyan as (0, 255, 255) etc. For most subtractive printers, with no undercolor removal, black is rendered by the maximum concentrations of the three image dyes, white by the absence of the three, red by the presence of magenta and yellow etc. Consequently the red signal is inversely mapped to the Cyan concentration, the green signal to Magenta and Blue to Yellow (where the term ‘inverse’ is construed in the manner utilized by the ‘invert image’ command in image processing software—i.e. 255 minus digital value.). Thus:

[C]∝(255−r)

[M]∝(255−g) 1.

[Y]∝(255−b)

For a 2-dye imaging system with Red and Cyan chromophores, a simple method of rendering the three-color image could be described as a special case of Eq. 1, in which the red dye is controlled by inverse of the average of the green and blue image values:

$$\begin{matrix}[ C ] ∝ ( 255 - r ) \\ [ R ] ∝ ( 255 - \frac{[ b + g ]}{2} ) .\end{matrix} \qquad 2$$

We note that a saturated red (255, 0, 0) is represented on the CRT by the chromaticity of the red phosphor and on the print by the chromaticity of the red image dye. While this method provides a well-defined mapping, the mapping is not preferred because the mapping is independent of the chromaticities of the two dyes, nor is it constructed- with any appreciation of the associated color errors.

Since the gamut of colors in the image space describes a three-dimensional solid, and the gamut of colors realizable with a two-dye system represent a two-dimensional surface, this transformation represents an extreme case of gamut mapping. The preferred mapping method described below projects all points in the three-dimensional color space onto the two dimensional surface specific to the two dye chromophores. Given the prevalence of Color Management Systems (CMS) in desktop computers, the preferred method leverages the (three-dimensional) tools of desktop CMS. In this method, the response space (L*a*b) of a “virtual” printer controlling three dyes is created, but one of those “dyes” is taken to be colorless. The resulting response space is a three-dimensional lookup table. This 3D look up table can be computed with a printer model or can be determined experimentally using a printer and the actual media. (In practice this printer will have only 2 control channels but we can extend the response space to three dimensions by replicating the measured 2 dimensional response space in the third dimension.)

This response space represents the space of realizable colors and is represented in an International Color Consortium (ICC) profile as the AtoB tags. (RGB in −> Lab out). When using a color management system to map an image into the printer control digit space the CMS effectively computes the color of each pixel and finds the printer digits that produce the color ‘closest’ to the desired color. In (ICC compatible) practice the CMS uses the inverse of an AtoB tag known as the BtoA tag (Lab in −> RGB out). The inversion of the AtoB tag effectively collapses the gamut of image colors onto the gamut of printer colors, subject to the notion of ‘closest to.’ The definition of ‘closest to’ is specified in terms of a metric imposed on the 3-dimensional color space. Visually uniform color spaces, such as CIELab or CIELuv are characterized by an intrinsic metric determined by the difference in two color that are judged to be 'just noticeably different. A uniform color space such as CIELab is characterized by three mutually orthogonal axes L*,a*,b*. The underlying space is said to be Euclidean, in that the apparent color difference between a color {L*,a*,b*} and a color characterized by {L*+ΔL*,a*+Δa*,b*+Δb*} is given by ΔE*:

ΔE*={square root over (((ΔL*)²+(Δa*)²+(Δb*)²))}

or

ΔE*={square root over (((ΔL*)²+(Δh*)²+(ΔC*)²))}

where h & C represent Chroma & Hue: 3.

(ΔC*)²=(Δa*)²+(Δb*)²

and

(Δh*)²=(ΔE*)²−(ΔL*)²−(ΔC*)²

Modifications have been made to the CIELab color difference formula to reflect the observations that surfaces of constant color difference represent ellipsoids rather than spheres and that the size of the ellipses vary throughout the color space (see, for example, Fairchild, M., Color Appearance Models, Addison Wesley, 1997). The resulting color difference formulas are expressed as a non Euclidean metric in the 3-D color space.

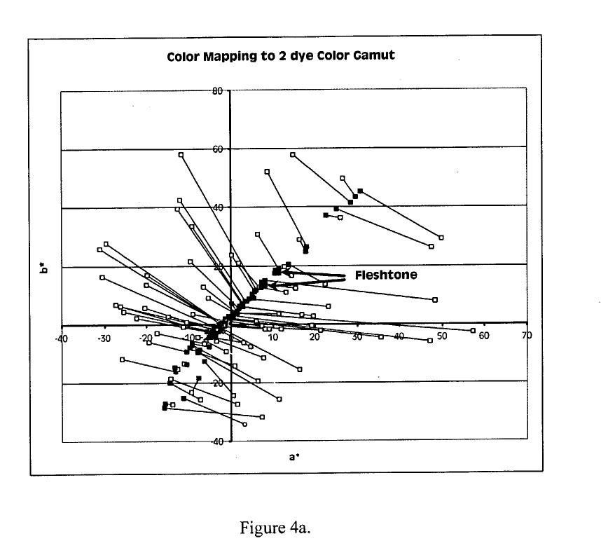

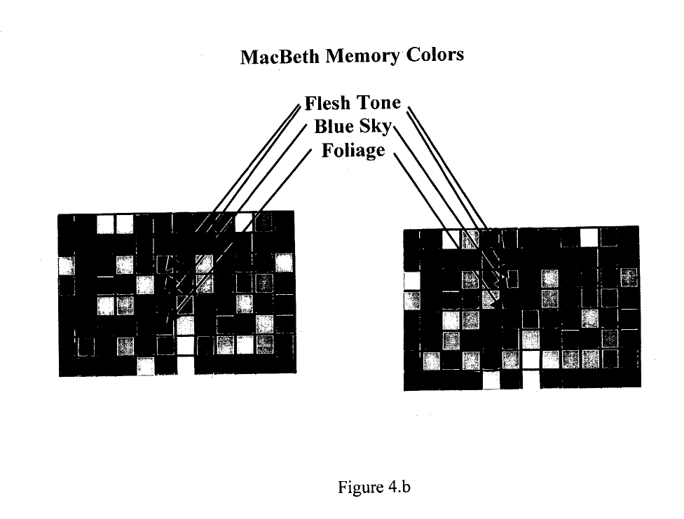

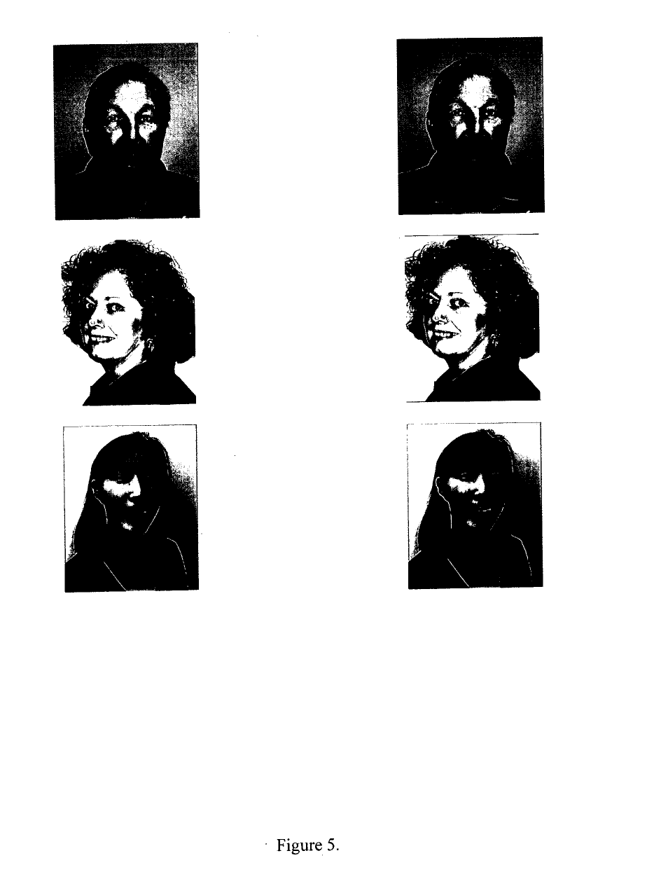

In practice the implementation of the metric distance ‘closest to’ is (often) performed in a uniform color space -L*a*b- with appropriate weighting of the three dimensional components of the color vector representing the color difference between the desired color and the printed color. These weights are applied to the error in Lightness, Chroma and Hue and have the consequence of determining the viewer's sensitivity to color difference errors in complex images. In our typical practice of three (or full) color gamut tucking, the L, C, and H errors are weighted in the ratio (2.5:1:10). In this invention, by choosing the dye chromophores such that the printer gamut lies very close to the subset of color representing skin tones and neutrals, the hue and chroma errors of the most important elements of full color images are minimized. It is clear that it is desired to minimize lightness errors. We find that it is preferable to render colors that lie outside the gamut as desaturated colors lying in the 2-color printer gamut. This can be accomplished by techniques well known in the art. For example, changing the color errors in the color difference formula as follows: increasing the L* error weighting and decreasing the Hue error weighting. While we have demonstrated that, in this invention, an L:C:H error-weighting ratio of (10:1:2.5) produces visually acceptable results, different weighting may produce images of higher quality. The effect of the color mapping onto the color gamut of the two dye system can be visualized by plotting the a* b* coordinates of a set of colors taken from an sRGB digital image of an expanded color chart composed of Munsell papers, including the memory colors in the MacBeth Test Chart, and their reproduction a*b* coordinates. These coordinates are computed by applying an sRGB ICC profile to the sRGB digital values to obtain the sRGB L*a*b*; these sRGB L*a*b* values are mapped to the 2 dye color gamut by applying an ICC profile obtained from the method described above to obtain the reproduction L*a*b* values. This process is displayed in FIG. 4a.

The method of the invention can be illustrated by applying the learning described above to the printing of complex images. It is well known in the field of Color Science that through the application of Color Management Systems images can be printed or displayed on a wide variety of devices and media in such a manner that they have the same appearance. While the various devices and media may have different color forming elements, each pixel is rendered on the devices such that if the color values are within the devices mutual color gamut, the rendered pixels will have the same color as described in a device independent color space. These principles lie behind the acceptance of ‘color proofing’ in the printing industry and ‘WYSIWYG’ color in the color graphics industry. In this spirit, we offer as illustrations of this invention, images that are ‘proofing images’ of the simulation of a model printer, in the manner described below.

Dye spectra for a complementary set of dyes are chosen as described above; they may represent either model or real dye chromophores.

We utilize a model of the spectral reflectance of dyes deposited on a substrate. The model should be specific to the printing technology—e.g. a Neugebauer model with dot gain for dot formed imaging systems. The examples illustrated here describe the reflectance of a continuously variable deposition of two dyes on a substrate with a measured spectral reflectance, utilizing a two pass geometry with correction for multiple reflections at the air interface. The same model is used to generate the color gamuts shown in FIGS. 1-3.

Color mapping from the full color space is performed in the manner described above.

FIGS. 4b and 5 show ‘proofing images’ that represent examples of applying the choice of chromophores and color mapping described in the present application to complex sRGB digital images. FIG. 4b gives visual demonstration of the color mapping displayed in FIG. 4a when applied to the color test target. FIG. 5 illustrates the application to portrait images of differing skin type.

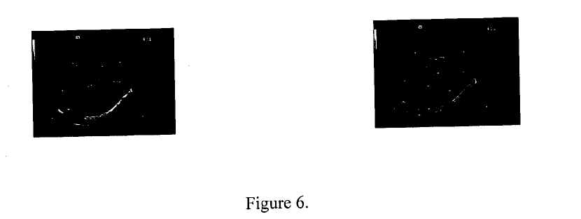

The desirability of a ‘Blue-Yellow’ complementary dye pair for the reproduction of certain medical diagnostic imagery was described above; an example of such an image reproduced as described above is shown in FIG. 6.

The resulting profiles are compatible with any ICC compliant color management system.

Printing System

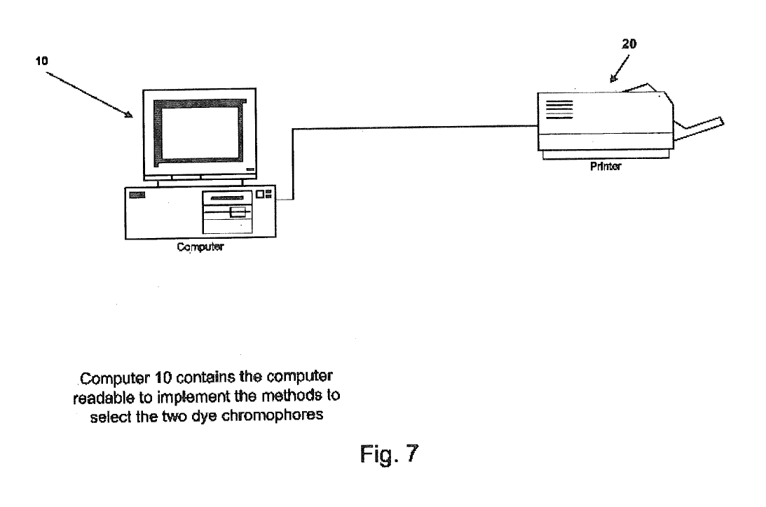

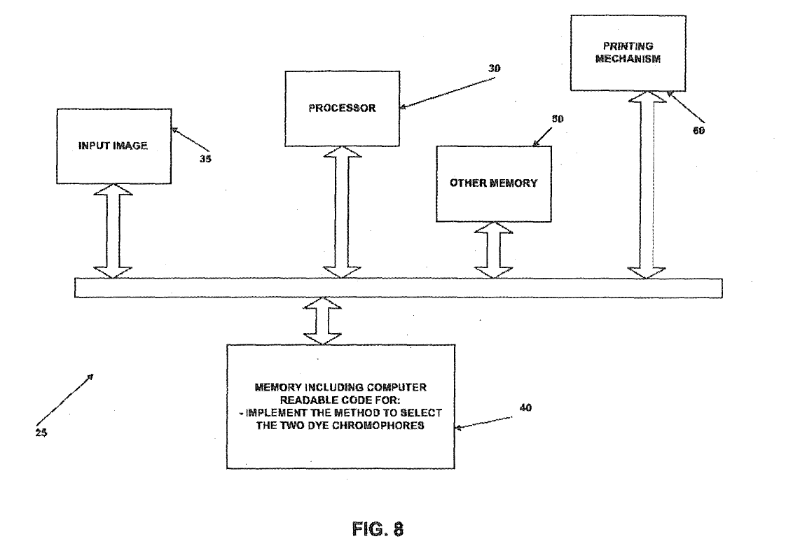

The methods described above can be embodied in a printing system utilizing two dye chromophores in order to render images with two dye chromophores. Such systems can comprise, as shown in FIG. 7, a computer 10 and a printer 20, or, as shown in FIG. 8, a printer 25 comprising a processor 30 and a computer readable memory 40. In both embodiments, the printing system comprises a processor and a computer readable memory. While, in the embodiment shown in FIG. 7, the processor and the memory are embedded in the computer 10, in the embodiment of FIG. 8, the processor 30 and the memory 40 are included in the printer 25. The printer 20 or 25 of FIGS. 7 and 8 can provide more than two dye chromophores and utilizing two of the dye chromophores, or combine dye chromophores to provide two resulting dye chromophores, to render an image. Or, the printer 20 or 25 of FIGS. 7 and 8 can provide the two dye chromophores obtained by the methods described above. The methods are included as a computer readable code embodied in computer usable medium. The computer readable code causes the computer system to execute the methods. The computer readable code can utilize or be part of a Color Management System (CMS).

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Elements and components described herein may be further divided into additional components or joined together to form fewer components for performing the same functions.

Although the invention has been described with respect to various embodiments, it should be realized this invention is also capable of a wide variety of further and other embodiments within the spirit and the appended claims.

What is claimed is:

1. A method of selecting two dye chromophores to render images comprising the steps of:
selecting a first dye chromophore;
selecting a second dye chromophore to be the complement of the first dye chromophore.

2. The method of claim 1 wherein the step of selecting the first dye chromophore further comprises the step of selecting the chromaticity of the first dye chromophore to produce a hue substantially equal to a fleshtone.

3. The method of claim 2 wherein the step of selecting the first dye chromophore further comprises the step of applying a model of the dye chromophore as transferred to a media substrate.

4. The method of claim 2 wherein the step of selecting the first dye chromophore further comprises the step of choosing the chromaticity of the first dye chromophore such that when combined with the complementary chromophore and the color of an underlying substrate the resulting spectral reflectance will produce the known hue of skin tone.

5. A method of selecting two dye chromophores to render images comprising the steps of:
selecting the chromaticity of a first dye chromophore such that when combined-with black in a determined strength and the color of an underlying substrate, the resulting spectral reflectance will produce the known hue of skin tone;
selecting black as a second dye chromophore.

6. A method of rendering images, said images comprised of discrete points each said point having a corresponding color value in an output color space, said corresponding color values comprising a space of all possible image color values , said output color space allowing the calculation of Lightness, Hue and Chroma values, said rendering obtained by means of a printing system utilizing two dye chromophores, said method comprising the steps of:
determining a mapping from the space of all possible image color values onto a reduced output color space defined by the two dye chromophore printing system;
constructing said mapping such that a point-in the space of all possible image color values is mapped to a closest point in the reduced two dye chromophore output space, wherein a distance between said closest point and said point in the space of all possible image color values is a closest distance;
rendering the image utilizing the two dye chromophores.

7. The method of claim 6 wherein said closest distance is computed by weighting differently Lightness errors, Hue errors, and Chroma errors in order to obtain a desired color rendering.

8. The method of claim 6 wherein said closest distance is computed by weighting Lightness errors greater than Hue errors and weighting Chroma errors less than the Hue errors.

9. A printing system providing at least two dye chromophores and utilizing two of said at least two dye chromophores to render an image, wherein said two of said at least two dye chromophores are selected by the steps of:
selecting a first dye chromophore;
selecting a second dye chromophore to be the complement of the first dye chromophore.

10. The printing system of claim 9 further comprising:
at least one processor;
at least one computer readable memory, said at least one computer readable memory having computer instructions embodied therein, said instructions causing the at least one processor to execute the steps to select said two of said at least two dye chromophores.

11. The printing system of claim 9 wherein the step of selecting the first dye chromophore further comprises the step of selecting the chromaticity of the first dye chromophore to produce a hue substantially equal to a fleshtone.

12. The printing system of claim 10 wherein the step of selecting the first dye chromophore further comprises the step of applying a model of the dye chromophore as transferred to a media substrate.

13. The printing system of claim 10 wherein the step of selecting the first dye chromophore further comprises the step of choosing the chromaticity of the first dye chromophore such that when combined with the complementary chromophore and the color of an underlying substrate the resulting spectral reflectance will produce the known hue of skin tone.

14. A printing system providing at least two dye chromophores and utilizing two of said at least two dye chromophores to render an image, wherein said two of said at least two dye chromophores are selected by the steps of::
selecting the chromaticity of a first dye chromophore such that when combined with black in a determined strength and the color of an underlying substrate, the resulting spectral reflectance will produce the known hue of skin tone;
selecting black as a second dye chromophore.

15. The printing system of claim 14 further comprising:
at least one processor;
at least one computer readable memory, said at least one computer readable memory having computer instructions embodied therein, said instructions causing the at least one processor to execute the steps to select said two of said at least two dye chromophores.

16. A printing system providing at least two dye chromophores and utilizing two of said at least two dye chromophores to render an image, said images comprised of discrete points , each said point having a corresponding color value in an output color space, said corresponding color values comprising a space of all possible image color values , said output color space allowing the calculation of Lightness, Hue and Chroma values, wherein said two of said at least two dye chromophores are selected by the steps of:
determining a mapping from the space of all possible image color values onto a reduced output color space defined by the two dye chromophore printing system;
constructing said mapping such that a point in the space of all possible image color values is mapped to a closest point in the reduced two dye chromophore output space, wherein a distance between said closest point and said point in the space of all possible image color values is a closest distance.

17. The printing system of claim 16 further comprising:
at least one processor;
at least one computer readable memory, said at least one computer readable memory having computer instructions embodied therein, said instructions causing the at least one processor to execute the steps to select said two of said at least two dye chromophores.

18. The printing system of claim 16 wherein said closest distance is computed by weighting differently Lightness errors, Hue errors, and Chroma errors in order to obtain a desired color rendering.

19. The printing system of claim 16 wherein said closest distance is computed by weighting Lightness errors greater than Hue errors and weighting Chroma errors less than the Hue errors.

20. A computer program product comprising:
a computer usable medium having computer readable code embodied therein for rendering images, said images comprised of discrete points each said point having a corresponding color value in an output color space, said corresponding color values comprising a space of all possible image color values , said output color space allowing the calculation of Lightness, Hue and Chroma values, said rendering obtained by means of a printing system utilizing two dye chromophores, said code causing a computer system to select the two dye chromophores by the steps of:
determining a mapping from the space of all possible image color values onto a reduced output color space defined by the two dye chromophore printing system;
constructing said mapping such that a point in the space of all possible image color values is mapped to a closest point in the reduced two dye chromophore output space, wherein a distance between said closest point and said point in the space of all possible image color values is a closest distance.

21. The computer program product of claim 9 where, in the computer readable code that causes a computer system to select the two dye chromophores, said closest distance is computed by weighting differently Lightness errors, Hue errors, and Chroma errors in order to obtain a desired color rendering.

22. The computer program product of claim 9 where, in the computer readable code that causes a computer system to select the two dye chromophores, said closest distance is computed by weighting Lightness errors greater than Hue errors and weighting Chroma errors less than the Hue errors.
